(19) United States
(12) Patent Application Publication
(10) Pub. No.: US 2007/0058011 A1
(43) Pub. Date: Mar. 15, 2007

(54) Method of cleaning an inkjet cartridge

(75) Inventor: Christopher Waclaw Wencel, Los Gatos, CA (US)

Correspondence Address: JAMES R. THEIN, 2231 CRYSTAL DRIVE, SUITE 105, ARLINGTON, VA, 22202, US

(73) Assignee: Christopher Waclaw Wencel

(21) Appl. No.: 11/222,978

(22) Filed: Sep. 12, 2005

(51) Int. Cl. B41J 2/175

(52) U.S. Cl. 347/86

(57) ABSTRACT

A recycled ink jet cartridge and a process of cleaning an ink jet cartridge is disclosed which includes a process for penetrating and cleaning a flow pipe located above the print head assembly just below a mesh filter. The cartridge is cleaned and reconditioned during the process. The present invention economizes the operational performance of ink cartridges which have been recycled and resealed, and provides a relatively simple, cost-effective process for removing dried ink from spent cartridges.

### FIELD OF THE INVENTION

The invention relates to the field of recycled ink jet cartridges and cleaning ink jet cartridges, and more specifically, to recycled ink jet cartridges and a method of cleaning ink jet cartridges through a cutting, cleaning , and vacuum process.

### BACKGROUND OF THE INVENTION

The recycling of ink jet cartridges by cleaning and refilling the reservoir is an environmentally safe way of handling plastic and chemical waste. Recycled inkjet cartridges offer clear advantages over new cartridges in cost, waste reduction, and sometimes even in product quality. In recycling, cartridges are opened, worn or defective pairs are replaced, and the cartridge is substantially cleaned, refilled, and reassembled.

Most cartridge recycling companies accept spent cartridges, reducing user-generated waste. Some original cartridge manufacturers offer end-of-life recycling from original buyers. Although the same environmental or economic benefits are far less, the effort does prevent spent cartridges from becoming waste.

Ink jet cartridges which are recycled by reputable companies exercising good quality control, will perform as well as or better than new cartridges. In some cases, the recycled ink jet cartridge may last longer and receive more ink than the original cartridge. Companies which operate cartridge recycling plants have improved drastically since it began in the 1980s and early 1990s. At that time, bootleggers and recyclers saw an easy way to make money and failed to properly remanufacture cartridges. A common practice was to use the “drill and fill” method to refill cartridges without taking appropriate steps to properly disassemble, refit, clean, and reassemble the cartridge. Buyers, who wanted to demonstrate environmental awareness were frustrated by poor product quality and unresponsive customer service from these disreputable companies. Today, many recycling companies offer warranties to the buyer regarding the ink jet printer as well as the cartridge.

Ink cartridges for ink jet printers typically contain one or more ink reservoirs which are emptied during the printing process. The cartridge includes a means of supplying ink to a print head that contains a number of ink micro chambers, each having an orifice or nozzle, and electrical circuitry to control the operation of the nozzles. In a conventional configuration, ink from a reservoir containing a sponge is supplied through a mesh filter to a print head assembly by a flow channel between the mesh filter and the print head assembly.

In a typical recycling process, the cartridge cap is removed along with the sponge. A cleaning solution is applied to the inside surface of the reservoir and the walls are cleaned with cotton. Thereafter, a new sponge is inserted into the reservoir along with ink and a new cap is applied and sealed to the cartridge. The mesh filter is generally not replaced because substitute filters exhibit a poor performance.

Other prior art cleaning methods are expensive and often fail to clean the areas where gunk accumulates which blocks the flow of ink. Conventional processes of ultrasonic cleaning and cleaning by centrifuge fail to clean the flow channels of what known in the industry as “shoe polish” which builds on the walls in the flow channel. Unless the mesh filter is removed, these prior art methods fail to move the cleaning fluid effectively past the mesh filter into the flow channel. For example, Wazana et al. 6,773,087 discloses a resealed inkjet printer cartridge and method of manufacture in which an ink cartridge is reconditioned, recharged and resealed by a centrifugation process which substantially eliminates “air lock”. Other methods, which remove the mesh filter have the problem of replacing the filter with an effective new filter.

There is a need in the industry for an effective means of cleaning the flow channel without removing the mesh filter. There is also a need in the industry of effectively cleaning, refilling and resealing an ink jet cartridge. A new process of cleaning an ink jet cartridge and a recycled ink jet cartridge is described herein.

### SUMMARY OF THE INVENTION

The present invention, in its several embodiments, economizes the operational performance of ink cartridges which have been recycled and resealed, and provides a relatively simple, cost-effective process for removing dried ink from spent cartridges.

It is a primary object of the present invention to provide an improved process of restoring depleted ink cartridges by eliminating dry ink just above the print head by a cutting, cleaning and resealing process.

It is another object of the present invention to provide an improved process of processing, recharging and resealing previously depleted ink jet cartridges which substantially eliminates dried ink and interruption of ink flow to and through the print head due to dried ink.

It is a further object of the present invention to provide a recycled ink jet cartridge with an inkless flow pipe to avoid interruption of ink flow to and through the ink micro chambers of the print head.

Another object of the present invention to provide an improved method of cleaning an ink jet cartridge without removing or placing filtering media above the flow pipe.

Yet, another object of the present invention to provide a method of cutting, cleaning and resealing ink cartridges.

An additional object of the present invention is to provide a process of cleaning recycled ink cartridges for use in a variety of different inkjet printer manufactures'0 printers.

### BRIEF DESCRIPTION OF THE DRAWINGS

The present invention detailed is illustrated by way of example and not limitation in the following figures.

FIG. 1 is a perspective view of a spent ink jet cartridge.

FIG. 2 is a partially exploded, perspective view of the spent ink jet cartridge as shown in FIG. 1.

FIG. 3 is a cross sectional view taken along lines 1-1 of FIG. 2 with the cap and sponge removed from the ink jet cartridge.

FIG. 4 is a top sectional view of the ink jet cartridge taken along lines 2-2 of FIG. 2 during a drilling process of the present invention.

FIG. 5 is a cross sectional view taken along lines 1-1 of FIG. 2 during a cleaning process of the present invention.

FIG. 6 is a cross sectional view taken along lines 1-1 of FIG. 2 during a vacuum process of the present invention.

FIG. 7 is a perspective view of a recycled ink jet cartridge of the present invention.

### DESCRIPTION OF THE PREFERRED EMBODIMENTS

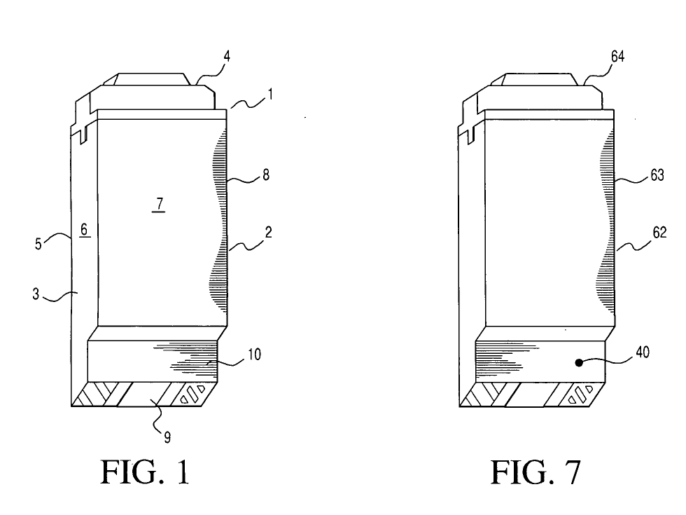

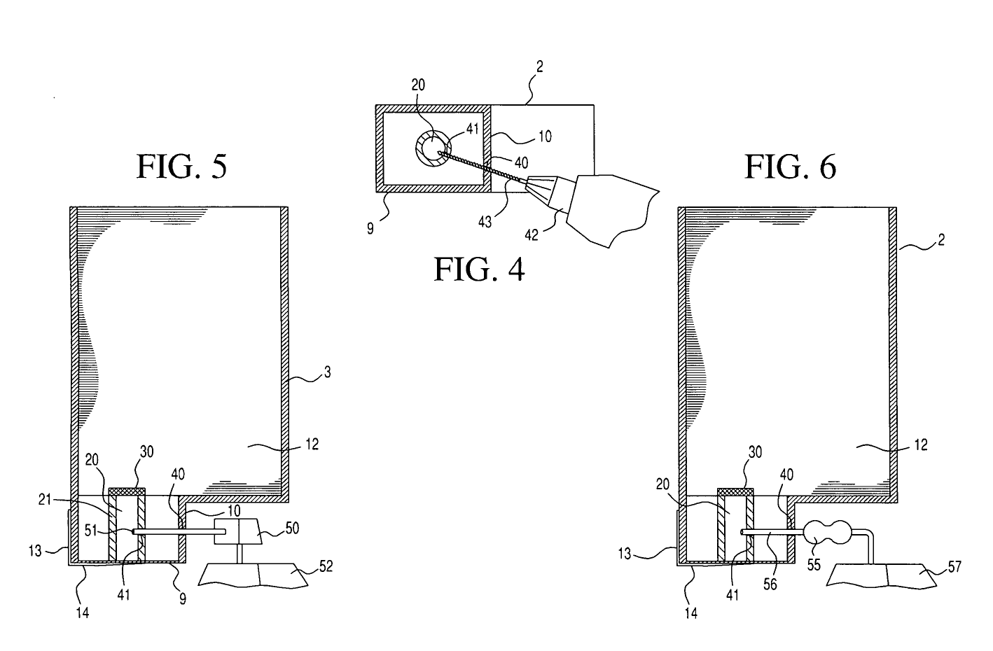

In accordance with the present invention, and with reference to FIGS. 1-7, a recycled ink jet cartridge and a process of manufacturing a recycled ink jet cartridge is depicted and described in detail.

Although the language of the specification describes an illustration of a particular ink jet cartridge, the description is not a limitation to the ink jet cartridge illustrated in the drawings. Also, ink jet cartridges are used to supply ink to an ink jet printer. Such ink jet printers are well known in the art and are not described in detail herein.

With reference to FIGS. 1-7, an ink jet cartridge assembly 1 is illustrated. The assembly includes a cartridge 2, a plastic housing 3 and a cap 4. The cap 4 is sealed to the housing 3. The housing has sidewalls 5, 6, 7, 8 and a bottom portion 9. Located on the bottom portion 9 is an entry wall 10.

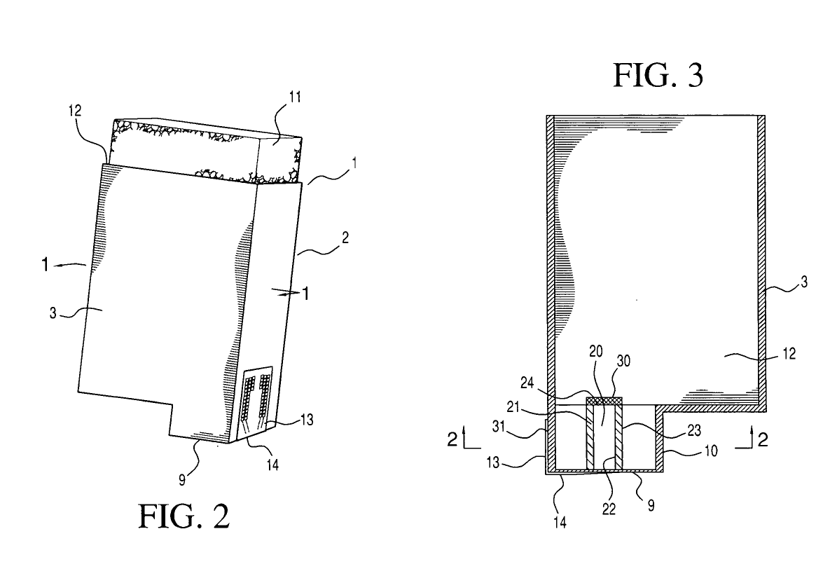

Typically, after an ink jet cartridge 2 has been emptied, the cap 4 is removed by cutting the cap 4 and the housing 3. Turning to FIG. 2, a partially exploded perspective view of the ink jet cartridge 2 is illustrated with the cap 4 removed from the housing 3. A sponge 11 is shown, partially extending from an ink reservoir 12. The reservoir 12 is filled with ink and the sponge is saturated with ink during use of the cartridge 2. After the reservoir 12 has been emptied the sponge 11 is no longer of use in the cartridge 2. Accordingly, and as shown in FIG. 2, the cap 4 has been removed to access the sponge 11. The sponge 11 is replaced by a new sponge after a cleaning process.

Also shown in FIG. 2 is a circuit tab 13 of a print heat assembly 14 which is attached to a wall 5 of the housing 3 and extends around bottom portion 9. The print head assembly 14 has micro chamber arrays which lead to printing nozzles, neither of which are shown. The circuit tab 13 remains part of the recycled cartridge after cleaning and refilling. The cap 4 is replaced with a new cap after the cleaning and refilling stages.

FIG. 3 depicts a side cross sectional view of the ink jet cartridge 2 taken along lines 1-1 of FIG. 2. Integrally formed with the ink jet housing 3 is a flow pipe 20 having a circular wall 21. The circular wall 21 has an inside surface 22, an outer surface 23 and a top surface 24. The flow pipe 20 extends from the reservoir 12 through the bottom portion 9 to provide a channel for the flow of ink to the micro chamber arrays of the print head assembly 14 and through the ink ejection nozzles which are not shown. A mesh filter is attached to the top surface 24 of the flow pipe 20. The mesh filter 30 prevents large particles of ink from entering the flow pipe 20 and clogging the cartridge 2. During use, gunk or shoe polish forms inside the flow pipe 20, especially on the inside surface 22.

Along with entry wall 10, the bottom portion 9 of the housing 3 has a circuit tab wall 31, a back side wall 32 and a front side wall 34. The circuit tab 13 is attached to the circuit tab wall 31 and extends around bottom wall 35 substantially covering the bottom wall 35. As the ink flows from the reservoir 12 through the mesh filter 30 down the flow pipe 20, the ink collects inside the bottom portion 9 and dispenses out through the print head assembly 14. The accumulation of ink past the mesh filter 30 causes the shoe polish to form on the inside surface 22 of the flow pipe 20.

In order to provide a recycled ink cartridge having the same or superior quality than the original cartridge 2, the inside surface 22 of the flow pipe 20 must be free of shoe polish. Moreover, the flow pipe 20 through the print head assembly 14 must be free of gunk in order to produce high print quality. While a specific cleaning process and recycled ink jet cartridge 2 will now be described, the invention is not limited to the construction of the illustrated cartridge. The invention is applicable to ink jet cartridges having multiple flow paths, each flow path using mesh filters over flow channels to the print head assembly.

After the step illustrated in FIG. 2 is complete and the sponge 11 has been removed, the reservoir 12 is cleaned using a cleaning or flushing solution to remove dried ink from inside the housing 3. FIG. 4 illustrates a top, cross sectional view of the cartridge 2 taken along lines 2-2 of FIG. 3. A first entry port 40 is made by cutting through the entry wall 10 and a second entry port 41 is cut through the circular wall 21 of the flow pipe 20 using a drill 42 with a 1/16^{th} inch bit 43 which is removed after penetrating through both walls, namely, 10 and 21. By cutting holes 40, 41 through two walls 10, 21, the cleaning process can now take place in an area deep inside the ink jet cartridge 2 in the last ink area prior to exiting the print head assembly.

The flow pipe 20 is now ready for the cleaning process. A cleaning tool 50 is used to send pressurized cleaning fluid or flushing solution into the flow pipe 20 by penetrating through both walls1O, 21, through the polls 40, 41. The cleaning tool 50 has a nozzle 51 which is inserted through the first entry port 40 and the second entry port 41. The cleaning tool 50 is connected to a cleaning fluid supply chamber 52 which holds a flushing solution. The cleaning fluid supply chamber 52 supplies flushing solution to the flow pipe 20 to clean the inside surface 22 of wall 21 of dried ink. The flushing solution is supplied to the flow pipe 20 at a pressure of 20-40 psi to scour the inside surface 22 and the mesh filter 24 with the flushing solution and by flushing the flow pipe and mesh filter, remove all the dried ink. Preferably, the flushing process lasts at least two minutes or until the dried ink is removed. After cleaning, a vacuum pump 55 having a nozzle 56 and a waste tank 57 is used to remove the cleaning fluid and dried ink. The nozzle 56 is inserted through the ports 40, 41 in both walls and the vacuum pump is operated to create suction inside the flow pipe. The nozzle 56 is then removed from the cartridge 2.

After flushing and vacuum, the cartridge may be submerged in water and treated with ultrasound for a final cleaning step. The general use of cleaning ink jet cartridges with ultrasound is well known in the art. An example of an ultrasound machine used to conduct the ultrasound cleaning process is sold under the name Branson Ultrasound Model 3510.

After the cleaning, the second entry port 41 is sealed with adhesive and then the first entry port 40 is sealed with adhesive, preferably silicone. A new sponge is then inserted into the cartridge 2 and the reservoir is filled with ink. A new cap 64 is sealed to the housing 3 and the recycled ink jet cartridge is ready for use.

As illustrated in FIG. 7, a recycled ink jet cartridge assembly 60 is presented for use. The assembly includes a cartridge 62, a plastic housing 63 and a cap 64. The cap 64 is applied to the housing 63 to seal the housing to the cartridge. The first and second entry ports 40, 41, have been sealed with adhesive so the pressure inside the cartridge 62 is maintained at a working level.

The present invention refines the operational performance of ink cartridges which have been recycled and resealed, and provides a relatively simple, cost-effective process for removing dried ink from spent cartridges. Furthermore, the present invention provides a process which substantially eliminates dry ink and interruption of ink flow to and through the print head due to dried ink. The recycled ink jet cartridge of the present invention further provides the buyer with an ink jet cartridge which in essence performs better than the originally purchased cartridge.

While the present invention has been described in connection with a particular ink jet cartridge configuration, the method may be used on any ink jet cartridge having a flow passage positioned below a filter and before the print head. While the present method of cleaning is considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

What is claimed is:

1. A process of recycling a used ink jet cartridge having dried ink inside said ink jet cartridge, said process comprising the steps of,
providing a used ink jet cartridge having a housing with a reservoir for holding ink, said housing having an entry wall, said housing having a flow pipe, said flow pipe having a circular wall with an inside surface coated with dried ink and a mesh filter covering said flow pipe, said cartridge having a print head to eject ink onto a printable media,
cutting a hole in said entry wall of said housing and cutting a hole in said circular wall of said flow pipe,
removing said dried ink from said reservoir by flushing said reservoir with a flushing solution,
inserting a cleaning tool through said hole in said entry wall of said housing and through said hole in said circular wall of said flow pipe,
flushing said flow pipe with flushing solution to remove said dried ink dried ink,
removing said flushing solution from said ink jet cartridge,
sealing said holes with adhesive to said flow pipe,
refilling said cartridge with ink and,
applying a cap to said cartridge to seal said housing.

2. The process of refilling an ink jet cartridge as recited in claim 1, said process including the further step of cutting said holes with a drill.

3. The process of recycling an ink jet cartridge as recited in claim 1, said process including the further step of removing said flushing solution with a vacuum process.

4. The process of recycling an ink jet cartridge as recited in claim 1, said process including the further step of cleaning said flow pipe with ultrasound after said flushing.

5. The process of recycling an ink jet cartridge as recited in claim 1, said process including the further step of flushing said reservoir with cleaning solvent prior to flushing said flow pipe.

6. The process of recycling an ink jet cartridge as recited in claim 1, said method including the further step of cleaning said reservoir with ultrasound while said cartridge is submerged under water.

7. The process of recycling an ink jet cartridge as recited in claim 1, said method including the further step of flushing said mesh filter and removing said dried ink from said filter.

8. A process of recycling a used ink jet cartridge having dried ink inside said ink jet cartridge, said process comprising the steps of,
providing a used ink jet cartridge having a housing with a reservoir for holding ink, said housing having an entry wall, said housing having a flow pipe, said flow pipe having a circular wall with an inside surface coated with dried ink and a mesh filter covering said flow pipe, said cartridge having a print head to eject ink onto a printable media,
cutting a hole in said entry wall of said housing and cutting a hole in said circular wall of said flow pipe,
removing said dried ink from said reservoir by flushing said reservoir with a flushing solution,
inserting a cleaning tool through said hole in said entry wall of said housing and through said hole in said circular wall of said flow pipe,
flushing said flow pipe with flushing solution to remove said dried ink dried ink,
removing said flushing solution from said ink jet cartridge,
sealing said holes with adhesive
refilling said cartridge with ink and,
applying a cap to said cartridge to seal said housing.

9. The process of recycling an ink jet cartridge as recited in claim 8, said process including the further step of cutting said holes with a drill.

10. The process of recycling an ink jet cartridge as recited in claim 8, said process including the further step of cleaning said flow pipe with ultrasound.

11. The process of recycling an ink jet cartridge as recited in claim 8, said process including the further step of removing said flushing solution with a vacuum process.

12. The process of recycling an ink jet cartridge as recited in claim 8, said method including the further step of flushing said reservoir with flushing solution.

13. The process of recycling an ink jet cartridge as recited in claim 8, said method including the further step of flushing said mesh filter and removing said dried ink from said filter.

14. The process of recycling an ink jet cartridge as recited in claim 8, said process including the further step of flushing said flow pipe for at least two minutes.

15. A recycled ink jet cartridge comprising,
a cleaned and previously depleted ink jet cartridge,
said ink jet cartridge having an entry wall which has been cut to provide an entry port and resealed, and
a flow pipe, said flow pipe having a circular wall which has been cut, cleaned with a flushing process and resealed.
